(19) United States
(12) Patent Application Publication
(10) Pub. No.: US 2013/0085840 A1
(43) Pub. Date: Apr. 4, 2013

(54) Methods and Systems for Real-Time Audience Tracking

(71) Applicant: IBT Internet Business Technologies, Odivelas (PT)

(72) Inventor: Parreira T. Andre, Odivelas (PT)

(73) Assignee: IBT Internet Business Technologies, Odivelas (PT)

(21) Appl. No.: 13/573,768

(22) Filed: Oct. 3, 2012

Related U.S. Application Data
(60) Provisional application No. 61/542,732, filed on Oct. 3, 2011.

(51) Int. Cl. G06Q 30/02

(52) U.S. Cl. 705/14.45

(57) ABSTRACT

At least one embodiment of this invention pertains to a method for tracking activities related to a tracking object such as an advertisement section in real time. The method includes maintaining a real-time communication channel with a user device, wherein the user device renders an application or a web page including a tracking object. Messages for events that a user of the user device is paying attention to or no longer paying attention to the tracking object are received from the user device through the real-time communication channel. The events are recorded to a database. A report for the tracking object is generated, wherein the report contains a number of users who have paid attention to the tracking object and the duration of time that each of the users has been paying attention to the tracking object.

### CROSS REFERENCE TO RELATED APPLICATIONS

This patent application claims priority to U.S. Patent Application No. 61/542,732, entitled METHODS AND SYSTEMS FOR TIME AND LOCATION BASED ADVERTISING MODELS, filed Oct. 3, 2011, the entire contents of which are incorporated herein its entirety.

This patent application is further related to the technologies described in the following patents and applications, all of which are incorporated herein in their entireties:
U.S. Provisional Patent Application No. 61/477,575, entitled METHOD, SYSTEM AND PRODUCTS FOR STANDARDIZED xRTML-MARKUP LANGUAGE FOR REAL-TIME WEB CONTENT PUBLISHING, filed Apr. 20, 2011;
U.S. Provisional Patent Application No. 61/477,579, entitled METHOD, SYSTEM AND PRODUCTS FOR STANDARDIZED ACCESS TO REAL-TIME FULL-DUPLEX WEB COMMUNICATIONS PLATFORM, filed Apr. 20, 2011; and
U.S. Provisional Patent Application No. 61/477,577, entitled METHODS, SYSTEMS AND PRODUCTS IN REAL-TIME TRACKING AND MARKETING INTERACTION WITH WEB APPLICATION USERS, filed Apr. 20, 2011.

### FIELD

This description generally relates to interactive web communication. More particularly, it relates to methods and systems for providing advertising models that are based on the location of viewers and the duration of their viewing the advertisement.

### BACKGROUND

E-Commerce is currently a reality in the business world and has been for several years. One of the main propelling forces of e-commerce is online advertising. Advertising companies place advertisements, for example, in the form of embedded widgets or banners or the like in strategic locations across the web. A great deal of innovation goes into the placement of the advertisements. A website owner receives compensation for placing an advertisement on the webpage of their website. However, the compensation is entirely dependent on the number of people who actually click on the advertisement and are led to a resulting page that embodies the subject of the advertisement. In most cases, when users visiting a web page see the advertisement, even without clicking the advertisement link, the advertiser gets at least some benefit of having advertised on that web page. But the webpage owner does not receive any compensation for having displayed the advertisement when the user does not specifically click on the banner or other advertisement section that displayed the advertisement.

Overall, the examples herein of some prior or related systems and their associated limitations are intended to be illustrative and not exclusive. Other limitations of existing or prior systems will become apparent to those of skill in the art upon reading the following Detailed Description.

### SUMMARY

Techniques introduced here provide a method for tracking activities related to a tracking object such as an advertisement section in real time. The tracking object can include an advertisement section, an advertisement placeholder, a webpage, an interactive session, a section of a website, an application section, an application interface, a media object or any other object as may be contemplated by a person of ordinary skill in the art. Activities that suggest a user is paying attention or not to the tracking object are tracked and communicated to a server. By recording the information of these events, the server recognizes the time and duration that a user gives their attention to the tracking object. Accordingly, the server can generate a report on the effectiveness of the tracking object (e.g. advertisement) based on the events. For example, the effective time period that users were actually paying attention to the tracking object can be calculated. The owner of the application, the webpage or website hosting the tracking object can receive credit based on the information gathered by the server such as the time and duration users pay attention to the tracking object, instead a simple total number of the users who click the link.

In at least one embodiment of the present invention, the method includes maintaining a real-time communication channel with a user device, wherein the user device renders an application, a web page including a tracking object. Examples of events for a user of the user device paying attention to the advertisement section or not paying attention to the tracking object are received as messages from the user device through the real-time communication channel. The events are recorded to a database. A report for the advertisement section is generated, wherein the report contains the number of users who have paid attention to the tracking object and the duration of time each user paid attention to the advertisement.

Other aspects of the technology introduced here will be apparent from the accompanying figures and from the detailed description which follows.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates a representative environment in which the invention can be implemented.

FIG. 2 illustrates a real-time web tracking system utilizing a real-time server to process data communications.

FIG. 3 is a block diagram illustrating components used to provide real-time full-duplex communication between clients and a server using an ORTC abstraction layer.

FIG. 4 illustrates information flows in an implementation of the real-time web tracking system.

FIG. 5 illustrates a sample process of remotely retrieving webpage content and status information in real-time.

FIG. 6 is a block diagram illustrating communication between an advertising section in a web page and corresponding control modules of a remove control server.

### DESCRIPTION OF THE INVENTION

References in this description to “an embodiment”, “one embodiment”, or the like, mean that the particular feature, function, or characteristic being described is included in at least one embodiment of the present invention. Occurrences of such phrases in this description do not necessarily all refer to the same embodiment, nor are they necessarily mutually exclusive.

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

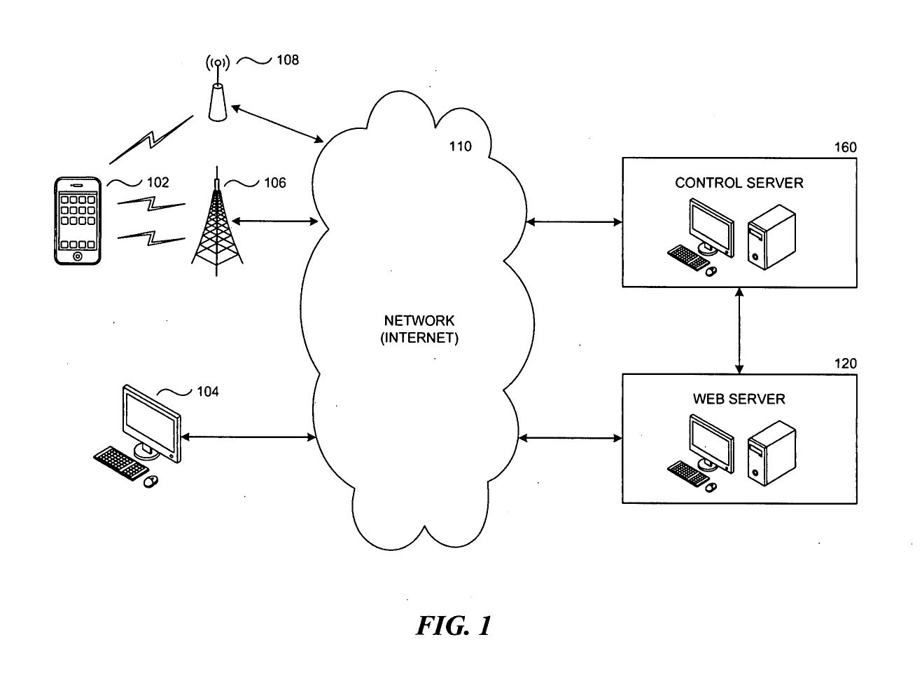

FIG. 1 and the following discussion provide a general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 1, a user may use a personal computing device (e.g., a phone 102, a personal computer 104, etc.) to communicate with a network. The term “phone,” as used herein, may be a cell phone, a personal digital assistant (PDA), a portable email device (e.g., a Blackberry®), a portable media player (e.g., an IPod Touch®), or any other device having communication capability to connect to the network. In one example, the phone 102 connects using one or more cellular transceivers or base station antennas 106 (in cellular implementations), access points, terminal adapters, routers or modems 108 (in IP-based telecommunications implementations), or combinations of the foregoing (in converged network embodiments).

In some instances, the network 110 is the Internet, allowing the phone 102 (with, for example, WiFi capability) or the personal computer 104 to access web content offered through various web servers. In some instances, especially where the phone 102 is used to access web content through the network 110 (e.g., when a 3G or an LTE service of the phone 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

In some instances, a user uses one of the personal computing devices (e.g., the phone 102, the personal computer 104, etc.) to connect to a web server 120 over the network 110. A web server, as defined herein, refers to any computing device that hosts or operates data pertaining to a website. In one example, the web server 120 is a server operates by an online clothing store company. In such an example, the web server 120 has local or remote access to a database comprising the online store's catalog of products and pricing information. The web server 120 may also include information, in the form of database scripts or high-level languages, relevant to receiving user input over the input and responding with content pertinent to the user's input. For example, if a user pays attentions to an advertisement for a particular designer shirt, the web server 120 includes capability to retrieve the relevant designer information and products from the database and return the information to the client such that the information is displayed on the user's personal computing device. The web server 120 also includes code relevant to hosting the web site and managing all interactive actions related to the hosted web site. In another example, the web server operates an interactive online networking model, where several users may operate concurrently in an interactive session. In some instances, such web sites offer places through which advertisements may be placed on behalf of either their own web site or for the benefit of other web site owners. For example, the web page displayed in a user's browser through the web server 120 (e.g., a search results website) may include advertisements related to third party products or services (e.g., advertisement related to sporting goods or a ski vacation package). In various embodiments, the advertisements may be placed on the web page in one or more of several formats. For example, in a first example, the advertisement may be in the form of a banner or a widget that is displayed or embedded within the web page. In one example, the advertisement may be a pop-up window or a display that may be displayed as an overlay of the existing web page or simply as an additional web page. In one example, the advertisement may be contained within the browser displaying the web page itself. Any other form of display of advertisement, as may be understood by a person of ordinary skill in the art, is also included as an example herein.

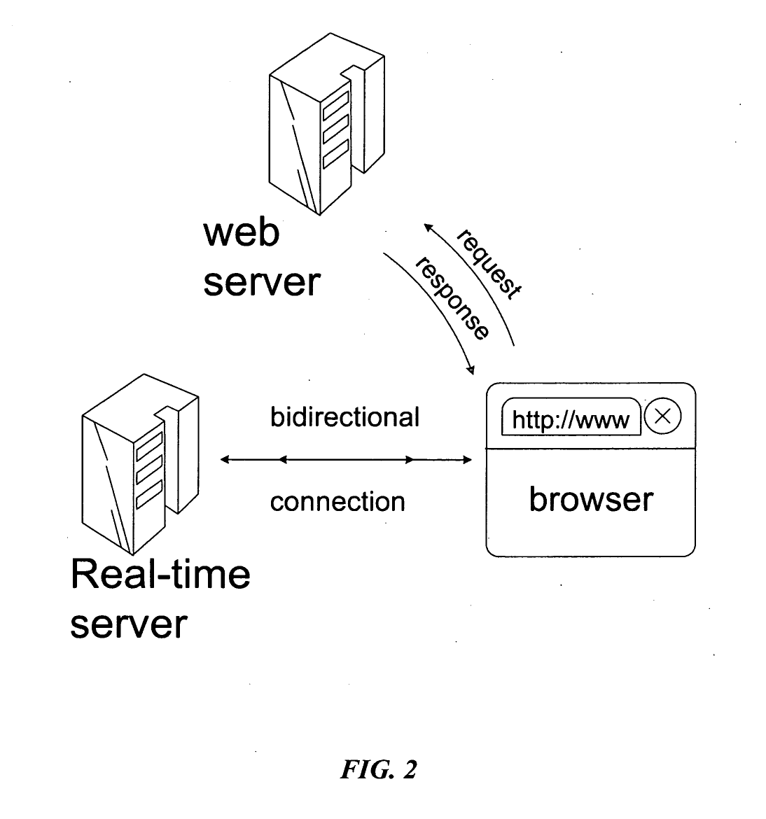

In some instances, such web advertisements may be controlled by a third-party control server, such as the server illustrated in FIG. 1 as control server 160. The control server, in instances, may control placement of appropriate and strategic advertisements in the advertising section of the web page. In some examples, and as is known in the prior art, when a user clicks on the advertising section, then the control server understands that there has been a visit through the web page operated by the web server in this particular case, and accordingly credits the web page owner a credit commensurate to the click. However, as is introduced in this application, credit is forwarded to the web page owner under a variety of different situations as well. Consider the case where a user merely scrolls over the advertising section without clicking on it. The indication here is that the user has at least seen or digested the advertisement displayed on the web page without completely partaking the full advertisement offered through the link. Accordingly, the web page owner is due some credit, even if not the full extent of credit that would have otherwise been available as a result of a click. The server can detect and control the behavior of the webpage rendered in the client devices in real time, as illustrated in FIG. 2.

FIG. 2 illustrates a real-time system utilizing a real-time server based on an Open Real-Time Connectivity (ORTC) interface to process the data communications between a web browser instance and the real-time control services.

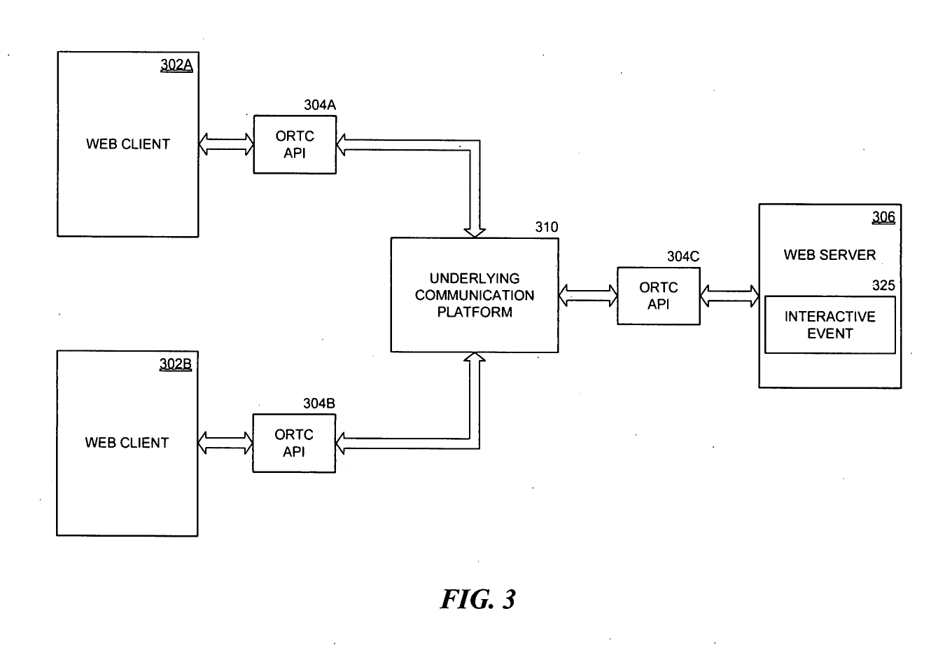

The real-time system not only has its communications handled by ORTC, allowing independence of the web server, but it can also freely read from and write to the web browser's rendered webpage Document Object Model (DOM). This means that the system can remotely execute methods to obtain information from a visitor's browser rendered page in real-time, and can further execute methods to change any element on the visitor's browser DOM, allowing its content to dynamically reflect any changes wanted, without that content being rendered by the web server in advance. The real-time duplex communication between servers and clients is achieved by an underlying ORTC layer as illustrated in FIG. 3.

FIG. 3 provides an illustration of the operation of the ORTC layer with reference to the underlying communication platform. In the illustrative embodiment of FIG. 3, web clients 302A and 302B are clients (e.g., web browsers rendering web pages from web server 306) connected to interactive event 325. The interactive event may be, for example, an advertisement hosted by web server 306. A unique ORTC layer operates as an abstraction layer between the web clients and underlying communication platform 310. In one embodiment, each web client interfaces with the ORTC layer using an ORTC API (or ORTC interface call). In some embodiments, the ORTC APIs are embedded HTML pages corresponding to the web pages rendered on the web clients. When the corresponding web pages are rendered by browsers in web client 302A, the embedded ORTC interface 304A invokes an interface with the ORTC layer, thus causing the web client to be ORTC enabled. When each web client establishes connection with the interactive event hosted by the web server, the embedded ORTC interface enables translation of the connection request and also causes certain listen channels to be established and able to receive status updates that may be broadcast by other web clients.

Similarly, web client 302B includes an embedded ORTC API 304B to enable web client 302B to be connected to underlying communication platform 310. Each ORTC API or interface causes the web client to invoke a connection to the ORTC layer. The ORTC layer, invoked as a result of the ORTC API in each client page, translates the connection requests (i.e., request to connect to interactive event 325) for the underlying communication platform 310 (e.g., HTML5 Web Socket). In some embodiments, the ORTC APIs also cause listen channels to be established for each connected web client. Such listen channels are established in the underlying communication platform, and are configured to receive updates about changes in status caused by any of the web clients.

Similar to the clients having an interface to the ORTC layer through ORTC APIs, the web server 306 may also additionally include an API 304C to the ORTC layer. Configured in such a manner, the web server may also have a listen channel to receive updates regarding status change events that affect the interactive event, and create logs or make changes as necessary. In some embodiments, the server-side API is meant to be used embedded in, for example, Microsoft's .NET applications (via C# or VBScript languages) or J2EE applications (via Java language).

In some embodiments, the client side ORTC APIs may be sufficient to establish the full duplex communication in updating the status of the interactive event with respect to each participating web client. For example, in some embodiments, each web client has an open listen channel established via interfaces to the ORTC layer. When one of the web clients broadcasts a message indicative of a change in status, the broadcast message is transported within the underlying communication platform and directly captured by each of the open listen channels without requiring a specific push event from the web server 220.

One of the advantages of the ORTC layer abstraction is the ability to allow an application (e.g., a web client) to interact with other applications in real-time over standard web ports (e.g., ports 80 and 443) without the applications being tied to a specific type of underlying communications platform. If the underlying communications platform needs to be changed for some other platform having an ORTC implementation, that change is accommodated without any change in the application's source code.

Using the ORTC abstraction layer not only provides freedom of choice from several real-time communication platform vendors, but also ensures that the application will be isolated from future evolutions in the underlying protocols, meaning that a new future full-duplex web communication technology (i.e., underlying communication platform) can be deployed without changing the application, thus drastically reducing the cost of upgrading and maintaining the web server.

In certain embodiments, the function of the ORTC layer is to translate requests (e.g., connection requests, update requests, response requests, etc.) that either emanate from the web client to a protocol that is discernable by the underlying communication platform. The ORTC layer comprises code necessary for performing the various operations (e.g., translating a connection request from a web client to the underlying communication protocol, receiving a broadcast message and identifying a specific call back function to invoke in a web client in response to the broadcast message, etc.). It is understood that such code may be implemented in any language or structure as may be understood by a person of ordinary skill in the art.

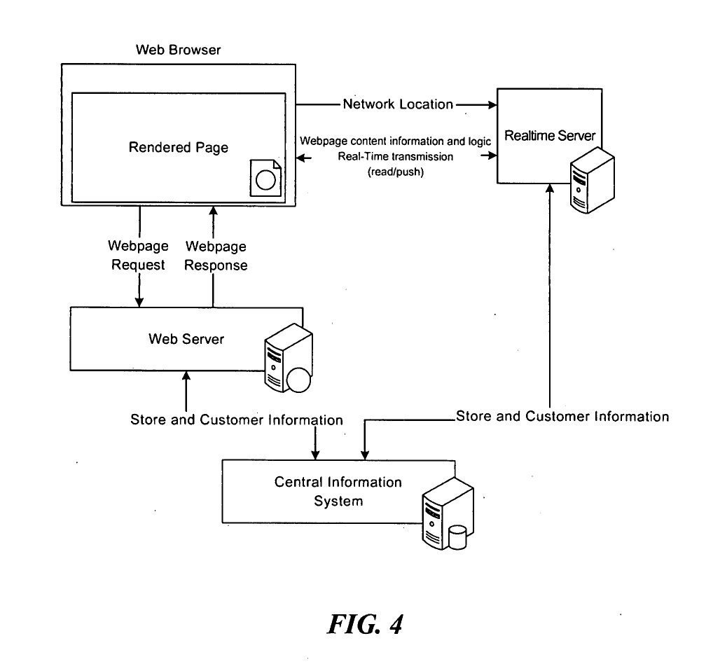

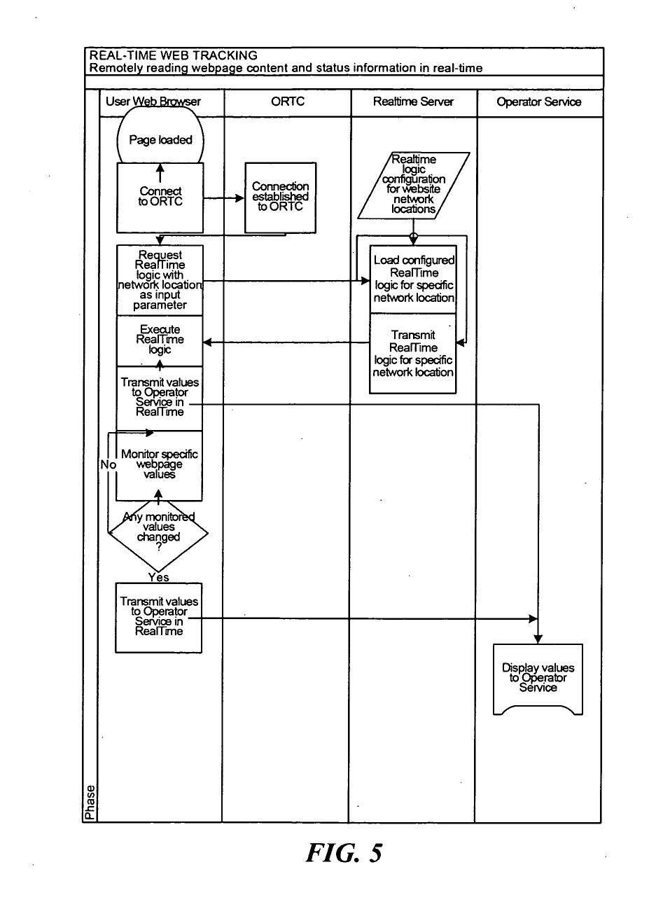

FIG. 4 illustrates information flows in an implementation of the real-time system. The web browser retrieves a web page from a web server and renders the web page. The real-time server interacts with the web browser directly for reading and pushing content dynamically in the web page. The real-time server monitors the status information related to the webpage and the web browser in real time. In some embodiments, the status information is stored on the real-time server, or on a central information system. In one embodiment, the real-time communications can be used to retrieve both webpage content and status information in real time, as illustrated in FIG. 5.

FIG. 5 illustrates a sample process of remotely reading webpage content and status information in real time. The web browser loads the web page and establishes a connection under an ORTC layer to the real-time server. In one embodiment, the web browser can send network location as an input parameter to request a real-time logic. The real-time server determines a real-time logic based on the specific network location and transmits the real-time logic to the web browser. The web browser executes the received real-time logic. According to the instructions of the real-time logic, the web browser transmits specific values related to the webpage to an operator service in real time and keeps monitoring these values. In one embodiment, the operator service is a functionality of the real-time server. In another embodiment, the operator service is built-in in a dedicated server separate from the real-time server. The values can be related to the content of the webpage being rendered, and/or related to the status information of the webpage, the web browser, or the device running the web browser. If any of these values is changed, the web browser will transmit and update the value to the operator service in real time.

Using the mechanism illustrated in FIG. 5, a real-time server can retrieve information about whether a user of a device is paying attention to a specific portion of the webpage or not in real time. For example, the real-time server is able to determine whether the user is paying attention to an advertisement section on the web page, as described in details in the following paragraphs.

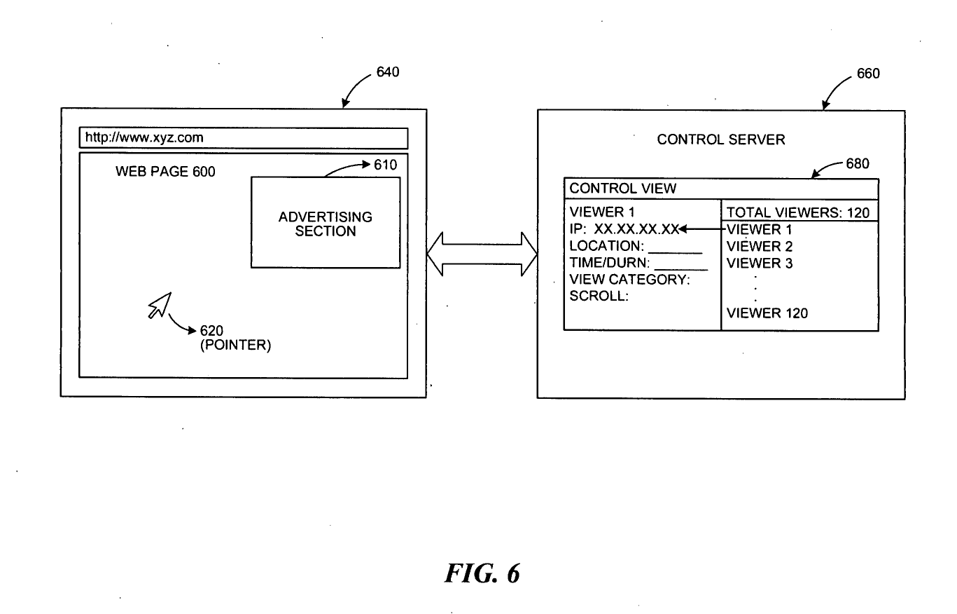

As illustrated in FIG. 6, the web page is built in such a manner that there is constant communication between the advertising section 620 displayed within web page 640 and the control server 660. Such real time communication and interactive capability may be achieved, for example, using the real-time server techniques that are discussed in previous paragraphs. Further, the ORTC techniques discussed above may also further be used to enable such real-time communication between the advertising section 610 and the control server 660. It is understood that the present invention further encompasses other techniques and methodologies, as may be known to a person of ordinary skill in the art, for the purpose of establishing communication between the advertising section and the control server 660.

Utilizing the real-time communication between the advertising section 610 and the control server 660, the control server 660 is able to monitors events related to the advertising section. In one embodiment, when the user hovers or scrolls his pointer 620 over the advertising section 610 (without even clicking on the advertising section), the event is recorded and sent to the control server 660 in real time. The control server 660 categorizes the event as an indication that the user is paying attention to the advertising section 610 and records the events.

The control server 660 is able to track the total time and the effective time for which a user (also referred to as the audience) has been paying attention to a tracking object, e.g. the advertising section. The effective time can be less than the total time. For example, a user opens a browser and browses a webpage for two minutes. Then the user minimizes the browser window or changes the focus to a different application window for another two minutes, before the user eventually closes the browser window. In this example, the effective time for the user paying attention to the webpage is two minutes, while the total time is four minutes.

In another example, the control server 660 is tracking the total and effective time for a banner on a webpage. The user browses and scrolls down the webpage for totally two minutes. When the user scrolls down the webpage, the banner has been displayed on the browser screen for twenty seconds. In this case, the effective time for the user paying attention to the banner is twenty seconds, while the total time is two minutes.

In one embodiment, the control server 660 includes a control view 680 as illustrated in FIG. 6. The control view 680 presents statistics related to the recorded event. Here, for example, the control view indicates that a user is currently viewing the advertisement. In some instances, the control view 680 may further illustrate a duration for which the user has been paying attention to (e.g., scrolling over or hovering over) the advertising section. In some examples, further details about the user, such as the user's IP or physical location may also be displayed. In some examples, a type of view is also displayed. In this example, the type of view is a user's action of scrolling over the advertising section 610. In some examples, the type of view may simply be a user's action of having a window actively open where the window includes the advertising section. In some other examples, a type of view may be a user's action of scrolling through a page and having the section of the web page that includes the advertising section. Other such examples, as may be contemplated by a person of ordinary skill in the art, may be considered examples of such types of view.

Similarly, the control server 660 can also receive information related to types of action indicating that the user is no longer paying attention to the advertising section 610. The types of action can include moving a pointer away from the advertisement section, moving a pointer away from the advertisement section when scrolling a mouse wheel, deactivating a window that is showing the advertisement section, or closing a window that is showing the advertisement section.

In one embodiment, the control view may further present other statistics, in lieu of or in addition to the above discussed user-level statistics. For example, the control view 680 may display a total number of users that are currently “viewing” (i.e. paying attention to) the advertising section 610 through their respective web pages. Such a display may further include a description of each user, for example, as a hyperlink, with each user's data being similar to the user-level statistical report discussed above (including IP, location information, etc.).

Accordingly, at any given moment, a control server operator would be able to report out the number of users that viewed an advertisement and the duration of time each of the users viewed the advertisement. The information of the duration of time can includes the effective time and/or the total time. Accordingly, the control server may be able to compute a credit that is commensurate to the number of views and duration of view, rather than merely crediting the web page owner a credit merely based on users clicking an advertisement.

In some embodiments, the techniques presented herein can be utilized to monitor tracking objects other than the advertising section, as may be contemplated by a person of ordinary skill in the art. For example, a tracking object being monitored by the control server can be a webpage, an interactive session, a section of a website, a section of an application, an advertisement placeholder or other tracking objects as intended to provide functionality to track a specific feature.

In one embodiment, for example, a comments section in a news detail page is tracked in real time by the control server. Any user activities regarding whether the user is paying attention to the comments section will be recorded and used to assess the effective time period for that comments section being paid attention. In other embodiments, the tracking objects being monitored by the control server may be a stock market widget in a portal homepage of a website, or a list of top 10 news in a website section.

The techniques presented herein can be utilized to track webpages as well as applications. For example, a tracking object of an application running on a mobile device operating system, e.g. iOS, Android, or Windows Phone, can be tracked in real time by a control server. The tracking object can be the application itself, or a section of the application. For example, the tracking object can be an advertising section of the application, a specific interface of the application, or a media object (e.g. an image, a video, a text, or an audio) within the application.

In addition to the above illustrated advantages, the techniques presented herein present additional advantages as discussed below.

In one example, the control server may be able to regulate the content of an advertisement based on a user's current viewing of the advertising section. For example, in an illustrative example, when the control server 660 detects that a user is actively looking at an advertisement (based on one of the types of view illustrated above), the control server may identify a specific physical location of the user or the user's personal preference (based e.g., on profiling the user's past history), the control server may at the moment push out a new ad that is personalized or catered or adapted more to the user's profile or location.

For example, the advertising section 610 may initially be configured only for ads for a sporting goods company. So, the advertising section may simply display “Visit XYZ.com for sporting goods.” Now, when a user is detected as having visited the advertising section, based on the user's location or profile information, the control server may update the advertising section to display, for example “Visit XYZ located in Folsom, Calif.” (based on the user's location), or “Visit XYZ for the latest discounts in fly fishing products” (based on the user's previously gathered profile data). Accordingly, the techniques discussed herein further allow advertisers to specifically target their advertising to users based on information about users that are presently viewing the advertisement.

In another illustrative embodiment, the control server may provide opportunities to see advertisements based on one or more parameters. Such parameters may include, for example, a total number of users that view the advertisement, a total duration of advertisement “view,” a total number of users of a particular physical location that will view the advertisement, etc. In one illustrative example, an entity wishing to place an advertisement may place an order for 1000 advertisements to be placed for people of a particular location or profile type, with each advertisement “viewed” for at least 15 seconds. Accordingly, in such an illustrative example, the control server would identify all views of advertising sections that match the parameter requirement (e.g., users in Folsom, Calif. or users interested in TV programming). When such views are detected, the control server may then update the advertising section with the specific advertisement, thus fulfilling the parameter based advertisement placement. Such placements of advertisements may be further refined or adjusted as specifically requested by entities seeking to place advertisements.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

We claim:

1. A method comprising:
maintaining a real-time communication channel with a user device, wherein the user device renders an application or a webpage including a tracking object;
receiving, from the user device through the real-time communication channel, a first message for a first event that a user of the user device is paying attention to the tracking object;
receiving, from the user device through the real-time communication channel, a second message for a second event that the user of the user device is no longer paying attention to the tracking object;
recording the first and second events to a database; and
generating a report for the tracking object based on the first and second events recorded in the database, wherein the report contains a number of users who have paid attention to the tracking object and the duration of time that each of the users has been paying attention to the tracking object.

2. The method of claim 1, wherein the tracking object includes an advertisement section, an advertisement placeholder, a webpage, an interactive session, a section of a website, an application section, an application interface, or a media object.

3. The method of claim 1, wherein the user device is a computer, a tablet, or a mobile device, and wherein the user device runs on an operating system of Windows, Mac OS, Linux, Unix, iOS, Android, WebOS, or Windows Phone.

4. The method of claim 1, wherein the duration of time includes effective time period that the users are paying attention to the tracking object.

5. The method of claim 1, further comprising:
calculating a credit amount for the tracking object based on the number of users and the durations of time of the report.

6. The method of claim 1, wherein the first event is that a pointer of the user device is hovering over the tracking object.

7. The method of claim 1, wherein the first event is that a pointer of the user device is hovering over the tracking object when a mouse wheel controlling the pointer is scrolled.

8. The method of claim 1, wherein the first event is that an actively open window of the user device is showing the tracking object.

9. The method of claim 1, wherein the first event is that the user of the user device scrolling through a page including the tracking object.

10. The method of claim 1, wherein the real-time communication channel is an Open Real-Time Connectivity (ORTC) channel.

11. The method of claim 1, further comprising:
deciding a new content based on a geographic profile, a demographic profile, an interest profile or an activity history of the user of the user device; and
transmitting the new content to the user device to be displayed on the tracking object of the user device.

12. The method of claim 1, further comprising:
calculating a credit amount for the tracking object based on the number of users, the durations of time of the report and a number of clicks on the tracking object.

13. A method comprising:
rendering an application or a webpage including a tracking object on a user device;
maintaining a real-time communication channel with a server;
sending, through the real-time communication channel to the server, a first message for a first event that a user of the user device is paying attention to the tracking object; and
sending, through the real-time communication channel to the server, a second message for a second event that the user of the user device is no longer paying attention to the tracking object.

14. The method of claim 13, wherein the first event includes an action of hovering a pointer over the tracking object, hovering a pointer over the tracking object when scrolling a mouse wheel, actively opening a window that is showing the tracking object, or scrolling through a page including the tracking object.

15. The method of claim 13, wherein the second event including an action of moving a pointer away from the tracking object, moving a pointer away from the tracking object when scrolling a mouse wheel, deactivating a window that is showing the tracking object, or closing a window that is showing the tracking object.

16. The method of claim 13, further comprising:
receiving a new content to be displayed on the tracking object, the new content has been selected by the server based on a geographic profile, a demographic profile, an interest profile or an activity history of the user.

17. A control server comprising:
a communication module configured to maintain a real-time communication channel with a user device, wherein the user device renders an application or a web page including a tracking object;
wherein the communication module is further configured to receive, from the user device through the real-time communication channel, a first message for a first event that a user of the user device is paying attention to the tracking object; and to receive, from the user device through the real-time communication channel, a second message for a second event that the user of the user device is no longer paying attention to the tracking object;
a storage module configured to record the first and second events to a database; and
a report module to generate a report for the tracking object based on the first and second events recorded in the database, wherein the report contains a number of users who have paid attention to the tracking object and the duration of time that each of the users has been paid attention to the tracking object.

18. The control server of claim 17, wherein the storage module is further configured to record an IP address or a physical address of the user device.

19. The control server of claim 17, wherein the storage module is further configured to record a type of action of the user of the user device.

20. The control server of claim 17, wherein the type of action is hovering a pointer over the tracking object, hovering a pointer over the tracking object when scrolling a mouse wheel, actively opening a window that is showing the tracking object, or scrolling through a page including the tracking object.

21. The control server of claim 17, further comprising:
a control view module configured to displaying a total number of users who are currently paying attention to the tracking object.

22. The control server of claim 21, wherein the control view module is further configured to displaying a description of each of the users, or a hyperlink to a statistical report of each of the users.

23. The method of claim 17, wherein the tracking object includes an advertisement section, an advertisement placeholder, a webpage, an interactive session, a section of a website, an application section, an application interface, or a media object.

24. The control server of claim 17, further comprising:
content selection module configured to select an content to be displayed on the tracking object on the user device, based on whether one or more parameters predetermined by an owner or a renter of the tracking object match a geographic profile, a demographic profile, an interest profile or an activity history of the user of the user device.
